(19) United States
(12) Patent Application Publication
(10) Pub. No.: US 2025/0087199 A1
(43) Pub. Date: Mar. 13, 2025

(54) ACTIVE NOISE CONTROL SYSTEM

(71) Applicant: ALPS ALPINE CO., LTD., Tokyo (JP)

(72) Inventor: Tomohiko ISE, Fukushima (JP)

(21) Appl. No.: 18/815,283

(22) Filed: Aug. 26, 2024

(30) Foreign Application Priority Data
Sep. 13, 2023 (JP) 2023-148546

(51) Int. Cl. G10K 11/178

(52) U.S. Cl. CPC G10K 11/17854; G10K 11/17823; G10K 11/17881; G10K 2210/3012; G10K 2210/3025

(57) ABSTRACT

An active noise control system includes circuitry configured to perform independent component analysis when a level of a sound output from a microphone becomes greater than a predetermined level. In an independent component analysis process, by the independent component analysis, the circuitry separates a noise component from monitoring sound data that is output from the microphone, and stores data representing the noise component as statistical noise data. An adaptive filter in the active noise control system performs an adaptive operation to adapt an output of the microphone as an error, and outputs, as a noise cancellation sound from a speaker, a sound represented by noise cancellation sound data that is obtained by filtering the stored statistical noise data. The adaptive filter adapts, as an error, a filter coefficient used in filtering the monitoring sound data output from the microphone.

### CROSS-REFERENCE TO RELATED APPLICATIONS

This application claims priority under 35 U.S.C. § 119 to Japanese Patent Application No. 2023-148546, filed Sep. 13, 2023, the contents of which are incorporated herein by reference in its entirety.

### BACKGROUND

### 1. Technical Field

The present disclosure relates to an active noise control system.

### 2. Description of the Related Art

A feedforward active noise control and a feedback active noise control are known in active noise control techniques (see Patent Document 1).

In the active noise control, events that correlate with noises such as vibrations or rotational speeds of a mechanism or sounds near a noise source are detected by a sensor, and as a result, a reference signal is generated. Here, the mechanism is used as the noise source that is situated upstream of a target position where a noise is to be canceled. In this case, an adaptive filter, which adapts, as an error signal, a sound collected by the microphone that is placed near the target position where the noise is to be canceled, generates a noise cancellation sound for canceling the noise in the reference signal, and outputs the noise cancellation sound from a speaker.

On the other hand, in the feedback active noise control, the adaptive filter generates the noise cancellation sound, and outputs the noise cancellation sound from the speaker. However, in the feedback active noise control, under a condition in which (i) a sound collected by the microphone that is placed near the target position is used as the error signal, and (ii) a signal obtained by adding, to the error signal, an estimated noise cancellation sound that is propagated from the speaker to the microphone is used as a noise signal representing a noise, the adaptive filter generates the noise cancellation sound for canceling the noise in the noise signal, and outputs the noise cancellation sound from the speaker.

Techniques in related art are known as including a technique (see Patent Document 2) for splitting a mixture of a sound and a noise into the sound and the noise by independent component analysis (ICA); and a technique (see Patent Document 3) for using a neural network to separate individual audio sources from audio signals that are sent from multiple audio sources.

In addition, the techniques in the related art are known as including a technique (see Patent Document 4) for determining a first principal component and a second principal component of the sound by principal component analysis in which data (variable) represents a sound intensity for each frequency band.

### RELATED-ART DOCUMENT

### Patent Document

[Patent Document 1] Japanese Unexamined Patent Application Publication No. 2017-090736

[Patent Document 2] Published Translation of PCT International Application No. 2006-510069

[Patent Document 3] Published Translation of PCT International Application No. 2009-511954

[Patent Document 4] Japanese Unexamined Patent Application Publication No. H11-117875

### SUMMARY

An active noise control system in the present disclosure includes a microphone configured to output a collected sound as a monitoring signal; a speaker configured to output a noise cancellation sound; an adaptive filter; a storage; and circuitry configured to perform a noise separation process at a predetermined timing, the noise separation process including separating a noise component from the monitoring signal, and storing, in the storage, a pseudo noise signal representing the noise component. The adaptive filter is configured to receive an input of the pseudo noise signal stored in the storage. The adaptive filter is configured to perform an adaptive operation to adapt the monitoring signal as an error, and generate the noise cancellation sound to be output from the speaker based on the pseudo noise signal.

An active noise control system in the present disclosure includes a microphone; circuitry configured to convert an output of the microphone to a frequency domain signal, and output the frequency domain signal as a monitoring signal; a speaker configured to output a noise cancellation sound; an adaptive filter; and a storage. The circuitry is configured to perform a noise separation process at a predetermined timing, the noise separation process including separating a noise component from the monitoring signal in a frequency domain, and storing, in the storage, a pseudo noise signal representing the noise component in the frequency domain. The adaptive filter is configured to receive an input of the pseudo noise signal stored in the storage, and perform an adaptive operation in the frequency domain to adapt the monitoring signal as an error. The circuitry is configured to convert an output of the adaptive filter to a time domain signal, and generate the noise cancellation sound to be output from the speaker.

In an active noise control system, circuitry may be configured to convert an output of a microphone to a frequency domain signal by a fast Fourier transform, and output the frequency domain signal as a monitoring signal, and convert an output of an adaptive filter to a time domain signal by an inverse fast Fourier transform.

An active noise control system in the present disclosure includes a microphone; circuitry configured to convert an output of the microphone to a weighting factor of a predetermined transformation function that generates a time domain signal by weighting an orthonormal basis, and output the weighting factor as a monitoring signal; a speaker configured to output a noise cancellation sound; an adaptive filter; and a storage. The circuitry is configured to perform a noise separation process at a predetermined timing, the noise separation process including separating a noise component from the monitoring signal and storing the noise component in the storage as a pseudo noise signal. The adaptive filter is configured to receive an input of the pseudo noise signal stored in the storage, and perform an adaptive operation to adapt the monitoring signal as an error. The circuitry is configured to convert an output of the adaptive filter to a time domain signal by the transformation function, and generate the noise cancellation sound to be output from the speaker.

In an active noise control system, circuitry may be configured to convert an output of a microphone to a frequency domain signal by a fast Fourier transform, and output the frequency domain signal as a monitoring signal, and convert an output of an adaptive filter to a time domain signal by an inverse fast Fourier transform.

In an active noise control system, circuitry may be configured to convert an output of a microphone to a weighting factor by a wavelet transform, output the weighting factor as monitoring signal, and convert an output of an adaptive filter to a time domain signal by an inverse wavelet transform.

In an active noise control system, circuitry may be configured to perform a noise separation process at a predetermined timing at which an output of a microphone becomes greater than a predetermined level.

In an active noise control system, circuitry may be configured to separate a noise component from a monitoring signal by independent component analysis.

In an active noise control system, circuitry may be configured to infer and separate a noise component from a monitoring signal by a neural network that is preliminarily trained to infer the noise component from the monitoring signal.

In an active noise control system, circuitry may be configured to calculate a principal component having a predetermined order of a monitoring signal by performing principal component analysis, and separate the principal component as a noise component.

In the active noise control system described above, a noise component in an output of a microphone that collects an error for adapting to an adaptive filter can be separated and stored as a pseudo noise signal, and a stored pseudo noise signal can be used as an input of the adaptive filter to generate a noise cancellation sound by active noise control. In addition, unlike a feedback active noise control, there is no problem in delay in propagation of a feedback loop that causes the noise to be not canceled successfully in a high frequency range. In addition, since pseudo noise data stored in advance is used as an input of the adaptive filter, in a feedforward active noise control, when a sensor that detects an event correlating with a noise at a position upstream of a target position where the noise is to be canceled is close to the target position, there is no problem that the noise cannot be canceled successfully in a high frequency range due to an insufficient computational time.

Therefore, in the present disclosure, in a blind configuration that does not include any sensor for detecting an event correlating with a noise at a position upstream of the target position, an active noise control that can cancel noise successfully in the high frequency range can be performed.

An active noise control system includes a microphone; circuitry configured to convert an output of the microphone to a weighting factor of a predetermined transformation function that generates a time domain signal by weighting an orthonormal basis, and output the weighting factor as a monitoring signal; a speaker configured to output a noise cancellation sound; an adaptive filter; and a storage that preliminarily stores, as a pseudo noise signal, the weight factor with which a pseudo noise is generated by the transformation function. The adaptive filter is configured to receive an input of the pseudo noise signal stored in the storage, and perform an adaptive operation to adapt the monitoring signal as an error. The circuitry is configured to convert an output of the adaptive filter to a time domain signal by the transformation function, and generate the noise cancellation sound to be output from the speaker.

In an active noise control system, circuitry may be configured to convert an output of a microphone to a weighting factor by a fast Fourier transform, to output the weighting factor as a monitoring signal, and convert an output of an adaptive filter to a time domain signal by an inverse fast Fourier transform.

In an active noise control system, circuitry may be configured to convert an output of a microphone to a weighting factor by a wavelet transform, to output the weighting factor as a monitoring signal, and convert an output of an adaptive filter to a time domain signal by an inverse wavelet transform.

### BRIEF DESCRIPTION OF THE DRAWINGS

FIG. 1 is a block diagram showing a configuration example of a noise controller according to a first embodiment.

FIG. 2 is a block diagram showing a configuration example of the noise controller according to a second embodiment.

FIG. 3 is a block diagram showing a configuration example of the noise controller according to a third embodiment.

FIG. 4 is a block diagram showing a configuration example of the noise controller according to a fourth embodiment.

FIG. 5 is a block diagram showing a configuration example of the noise controller according to a fifth embodiment.

FIG. 6 is a block diagram showing a configuration example of the noise controller according to a sixth embodiment.

FIG. 7 is a block diagram showing a configuration example of the noise controller according to a seventh embodiment.

FIG. 8 is a block diagram showing a configuration example of the noise controller according to an eighth embodiment.

FIGS. 9A and 9B are block diagrams showing a configuration example of the noise controller according to a ninth embodiment.

### DETAILED DESCRIPTION

The inventor of this application has recognized the following information in the related art. A feedforward active noise control requires a special sensor, in addition to a microphone for collecting an error for adapting to an adaptive filter that is arranged near a target position where a noise is to be canceled. In order to generate a reference signal, the special sensor detects an event that correlates with the noise at a position upstream of the noise from a target position where the noise is to be canceled. If such a sensor is not provided, the active noise control could not be implemented.

On the other hand, a feedback active noise control does not require both the sensor for detecting the event that correlates with the noise and the microphone arranged near the target position where the noise is to be canceled. However, there is a problem that it is difficult to cancel the noise in a high frequency range due to a delay in propagation of a feedback loop.

In addition, in the feedforward active noise control, when the sensor for detecting the event that correlates with the noise is close to the target position, a computational time for generating a necessary component of the noise cancellation sound in the high frequency range is insufficient. As a result, it becomes difficult to successfully cancel the noise in the high frequency range.

In view of the situation recognized by the inventor, an object of the present disclosure is to implement an active noise control capable of successfully canceling a noise even in a high frequency range, by using a blind configuration with no sensor for detecting an event correlating with the noise at a position upstream of the noise from a target position where the noise is to be canceled.

Hereinafter, various embodiments will be described.

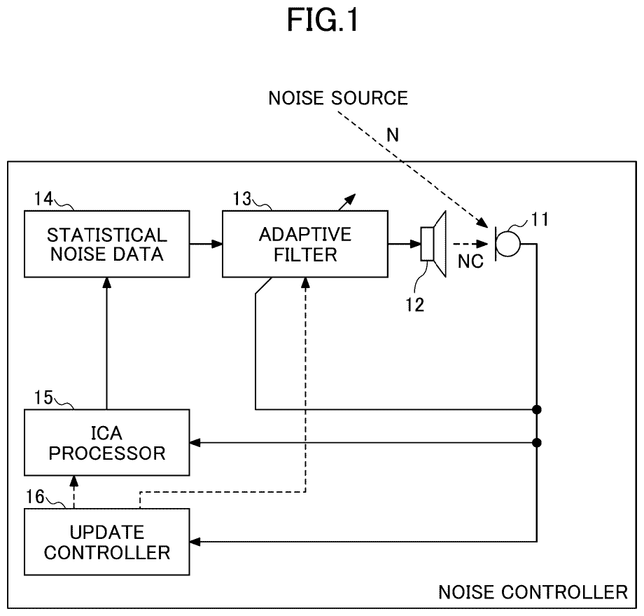

First, a first embodiment will be described as follows. FIG. 1 shows a configuration example of a noise controller according to the first embodiment. As shown in FIG. 1, the noise controller includes a microphone 11 arranged near a target position where a noise is to be canceled (hereinafter may be referred to as the target position), a speaker 12 for outputting a noise cancellation sound NC for canceling a noise N at the target position, an adaptive filter 13, statistical noise data 14, an independent component analysis (ICA) processor 15 for performing independent component analysis (ICA), and an update controller 16.

The microphone 11 outputs mixed audio of a collected noise N and the noise cancellation sound NC, as monitoring sound data. When the noise cancellation sound NC is output from the speaker 12, mixed audio data represents a remaining component of the noise N that is not entirely canceled by the noise cancellation sound NC.

When the noise controller is set up or a sound level represented by the monitoring sound data output from the microphone 11 becomes greater than or equal to a predetermined level, the update controller 16 stops the operation of the adaptive filter 13, and causes the ICA processor 15 to perform the independent component analysis.

While the operation of the adaptive filter 13 is stopped, both an adaptive operation of the adaptive filter 13 and the outputting of the noise cancellation sound NC are stopped. In this arrangement, during a time period in which the operation of the adaptive filter 13 is stopped, the monitoring sound data output from the microphone 11 represents the noise N.

In an independent component analysis process, by independent component analysis, the ICA processor 15 separates a noise component from the monitoring sound data output from the microphone 11, based on statistical independence, and then stores data representing the noise component as statistical noise data 14.

When the statistical noise data 14 is stored, the update controller 16 resumes the operation of the adaptive filter 13.

The stored statistical noise data 14 is output to the adaptive filter 13 as pseudo noise data.

As the noise cancellation sound NC, the adaptive filter 13 outputs, from the speaker 12, the sound represented by the noise cancellation sound data that is obtained by filtering input pseudo noise data. In addition, the adaptive filter 13 adapts, as an error of the monitoring sound data output from the microphone 11, a filter coefficient used in filtering the pseudo noise data by an adaptive algorithm such as least mean squares (LMS) or normalized least mean squares (NLMS), so as to minimize error power.

Hereinafter, a second embodiment will be described. In the second embodiment, signal processing, which resembles the operation of the noise controller according to the first embodiment, is performed in a frequency domain.

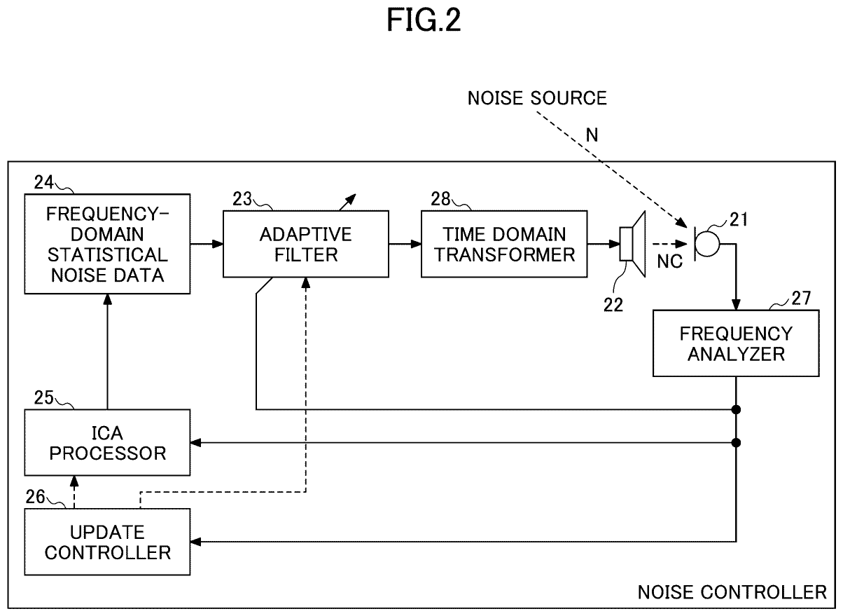

FIG. 2 shows the configuration of the noise controller according to the second embodiment.

As shown in FIG. 2, the noise controller includes a microphone 21 arranged near a target position where a noise is to be canceled, a speaker 22 that outputs the noise cancellation sound NC for canceling the noise N at the target position, an adaptive filter 23, frequency-domain statistical noise data 24, an ICA processor 25 for performing independent component analysis (ICA), an update controller 26, a frequency analyzer 27, and a time domain transformer 28.

The frequency analyzer 27 performs frequency analysis on monitoring sound data that is output from the microphone 21, and converts the monitoring sound data to frequency-domain monitoring sound data that represents a sound intensity in each frequency band.

In the frequency analysis performed by the frequency analyzer 27, for example, a fast Fourier transform (FFT) can be used. When the FFT is used, the frequency-domain monitoring sound data represents a frequency spectrum.

When the noise controller is set up, or it is detected that a sound level represented by the monitoring sound data output from the microphone 21 becomes greater than or equal to a predetermined level, the update controller 26 stops the operation of the adaptive filter 23, and causes the ICA processor 25 to perform independent component analysis.

In an independent component analysis process, the ICA processor 25 performs independent component analysis in the frequency domain, then separates, from the frequency-domain monitoring sound data, data representing a noise component in the frequency domain based on statistical independence, and ultimately stores the data separated from the frequency-domain monitoring sound data, as the frequency-domain statistical noise data 24.

Here, when the FFT is used in the frequency analysis performed by the frequency analyzer 27, the frequency-domain statistical noise data 24 represents a frequency spectrum.

When the statistical noise data 14 is stored, the update controller 26 resumes the operation of the adaptive filter 23.

The stored frequency-domain statistical noise data 24 is output to the adaptive filter 23 as frequency domain pseudo noise data.

The adaptive filter 23 filters input frequency-domain pseudo noise data in the frequency domain, and outputs the resulting data to the time domain transformer 28 as frequency-domain noise cancellation sound data. In addition, the adaptive filter 23 adapts, as an error of the frequency-domain monitoring sound data output from the frequency analyzer 27, a filter coefficient used in filtering the frequency-domain pseudo noise data by an adaptive algorithm such as least mean squares (LMS) or normalized least mean squares (NLMS), so as to minimize error power.

The time domain transformer 28 converts the frequency-domain noise cancellation sound data output from the adaptive filter 23, to a time domain sound, and then outputs, from the speaker 22, a time domain sound as the noise cancellation sound NC.

When the FFT is used in the frequency analysis performed by the frequency analyzer 27, an inverse fast Fourier transform (IFFT) is performed by the time domain transformer 28.

Hereinafter, a third embodiment will be described. In the third embodiment, instead of the independent component analysis (ICA), a neural network is used to separate the noise from monitoring sound data at the noise controller according to the first embodiment.

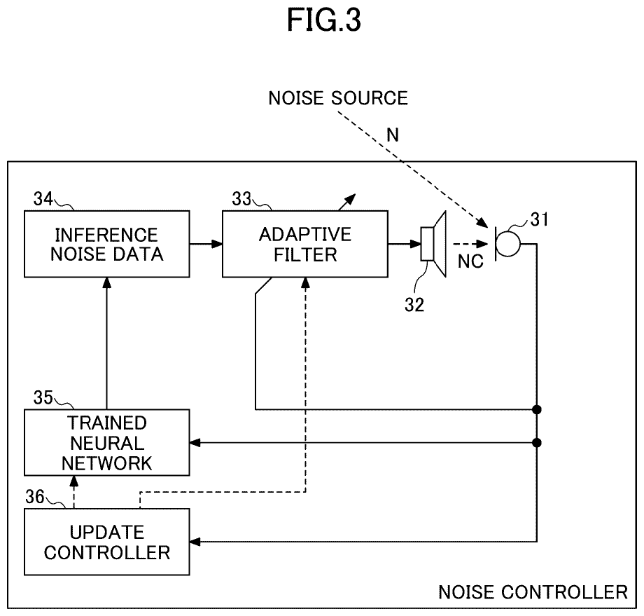

FIG. 3 shows the configuration of the noise controller according to the third embodiment.

As shown in FIG. 3, the noise controller includes a microphone 31 arranged near a target position where the noise is to be canceled, a speaker 32 that outputs a noise cancellation sound NC for canceling the noise N at the target position, an adaptive filter 33, inference noise data 34, a trained neural network 35, and an update controller 36.

The microphone 31 outputs mixed audio of a collected noise N and the noise cancellation sound NC, as the monitoring sound data.

When the noise controller is set up, or it is detected that a sound level represented by the monitoring sound data output from the microphone 31 becomes greater than or equal to a predetermined level, the update controller 36 stops the operation of the adaptive filter 33, and causes the trained neural network 35 to perform a noise inference process.

The trained neural network 35 is a neural network that is obtained by performing learning in advance to perform inference in which a noise component is separated from the monitoring sound data by using appropriate training data. In a noise inference process, the noise is inferred from the monitoring sound data that is output from the microphone 31, and then data representing the inferred noise is stored as the inference noise data 34.

When the inference noise data 34 is stored, the update controller 36 resumes the operation of the adaptive filter 33.

The stored inference noise data 34 is output to the adaptive filter 33 as pseudo noise data.

As the noise cancellation sound NC, the adaptive filter 33 outputs, from the speaker, a sound represented by the noise cancellation sound data that is obtained by filtering input pseudo noise data. In addition, the adaptive filter 33 adapts, as an error of the monitoring sound data output from the microphone 31, a filter coefficient used in filtering the pseudo noise data by an adaptive algorithm such as LMS or NLMS, so as to minimize error power.

Hereinafter, a fourth embodiment will be described.

In the fourth embodiment, signal processing, which resembles the operation of the noise controller according to the third embodiment, is performed in the frequency domain.

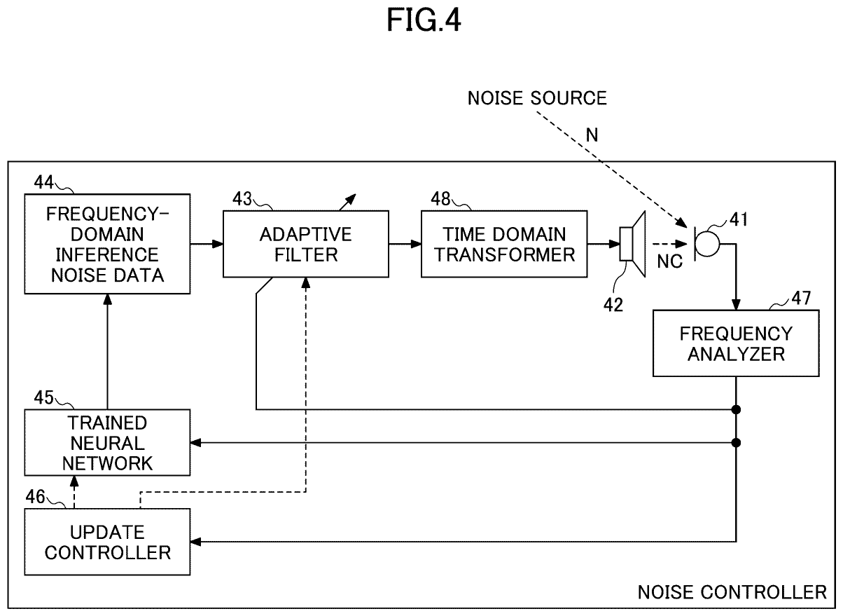

FIG. 4 shows the configuration of the noise controller according to the fourth embodiment.

As shown in FIG. 4, the noise controller includes a microphone 41 arranged near a target position where a noise is to be canceled, a speaker 42 that outputs a noise cancellation sound NC for canceling a noise N at the target position, an adaptive filter 43, frequency-domain inference noise data 44, a trained neural network 45, an update controller 46, a frequency analyzer 47, and a time domain transformer 48.

The frequency analyzer 47 performs frequency analysis on monitoring sound data output from the microphone 41, and converts the monitoring sound data to frequency-domain monitoring sound data that represents a sound intensity in each frequency band.

In the frequency analysis performed by the frequency analyzer 47, a fast Fourier transform (FFT) can be used, for example. When the FFT is used, the frequency-domain monitoring sound data represents a frequency spectrum.

When the noise controller is set up or it is detected that a sound level represented by the monitoring sound data output from the microphone 41 becomes greater than or equal to a predetermined level with reference to the frequency-domain monitoring sound data, the update controller 46 stops the operation of the adaptive filter 43, and causes the trained neural network 45 to perform the noise inference process.

The trained neural network 45 is a neural network that is obtained by performing learning in advance using appropriate training data, and that performs inference to separate a noise component in the frequency domain from the frequency-domain monitoring sound data. In the noise inference process, the noise component is inferred from the frequency-domain monitoring sound data in the frequency domain, and data representing an inferred noise component in the frequency domain is stored as the frequency-domain inferred noise data 44.

Here, when the FFT is used in the frequency analysis performed by the frequency analyzer 47, the frequency-domain inference noise data 44 represents a frequency spectrum.

When the frequency-domain inference noise data 44 is stored, the update controller 46 resumes the operation of the adaptive filter 43.

The stored frequency-domain inference noise data 44 is output to the adaptive filter 43 as frequency-domain pseudo noise data.

The adaptive filter 43 filters input frequency-domain pseudo noise data, and outputs the resulting data to the time domain transformer 48 as frequency-domain noise cancellation sound data. In addition, the adaptive filter 43 adapts, as an error of the frequency-domain monitoring sound data output from the frequency analyzer 47, a filter coefficient used in filtering the frequency-domain pseudo noise data by an adaptive algorithm such as LMS or NLMS, so as to minimize error power.

The time domain transformer 48 converts the frequency-domain noise cancellation sound data output from the adaptive filter 43, to a time domain sound, and outputs, from the speaker 42, the time domain sound as the noise cancellation sound NC.

When the FFT is used in the frequency analysis performed by the frequency analyzer 47, an inverse fast Fourier transform (IFFT) is performed by the time domain transformer 48.

Hereinafter, a fifth embodiment will be described.

In the fifth embodiment, instead of the independent component analysis (ICA), principal component analysis is used to separate a noise from the monitoring sound data at the noise controller according to the first embodiment.

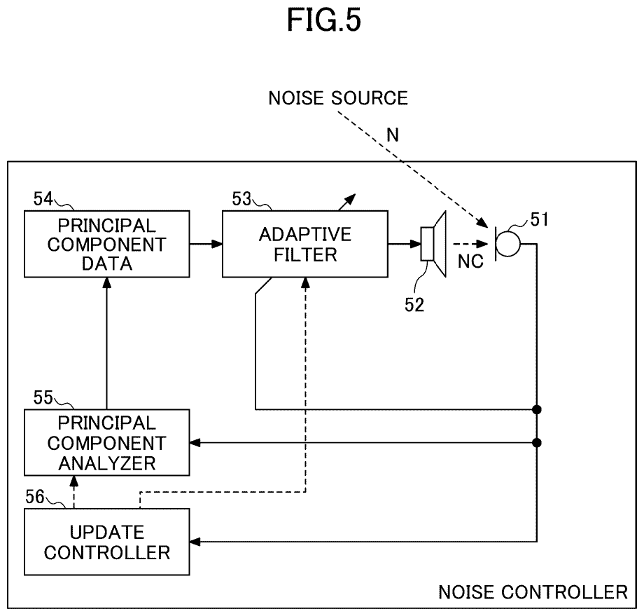

FIG. 5 shows the configuration of the noise controller according to the fifth embodiment.

As shown in FIG. 5, the noise controller includes a microphone 51 arranged near a target position where a noise is to be canceled, a speaker 52 that outputs a noise cancellation sound NC for canceling a noise N at the target position, an adaptive filter 53, principal component data 54, a principal component analyzer 55, and an update controller 56.

The microphone 51 outputs a mixed sound of a collected noise N and the noise cancellation sound NC as monitoring sound data.

When the noise controller is set up, or a sound level represented by the monitoring sound data output from the microphone 51 becomes greater than or equal to a predetermined level, the update controller 56 stops the operation of the adaptive filter 53, and causes the principal component analyzer 55 to perform principal component analysis.

By the principal component analysis, the principal component analyzer 55 analyzes one or more principal components (for example, only the first principal component, only the second principal component, or both the first principal component and the second principal component) having predetermined orders of the monitoring sound data, and stores, as principal component data 54, data representing a sound having a maximum proportion of variance for one or more analyzed principal components.

When the principal component data 54 is stored, the update controller 56 resumes the operation of the adaptive filter 53.

The stored principal component data 54 is output to the adaptive filter 53 as pseudo noise data.

As the noise cancellation sound NC, the adaptive filter 53 outputs, from the speaker 52, a sound represented by the noise cancellation sound data that is obtained by filtering input pseudo noise data. In addition, the adaptive filter 53 adapts, as an error of the monitoring sound data output from the microphone 51, a filter coefficient used in filtering the pseudo noise data by an adaptive algorithm such as LMS or NLMS, so as to minimize error power.

Hereinafter, a sixth embodiment will be described.

In the sixth embodiment, signal processing, which resembles the operation of the noise controller according to the fifth embodiment, is performed in the frequency domain.

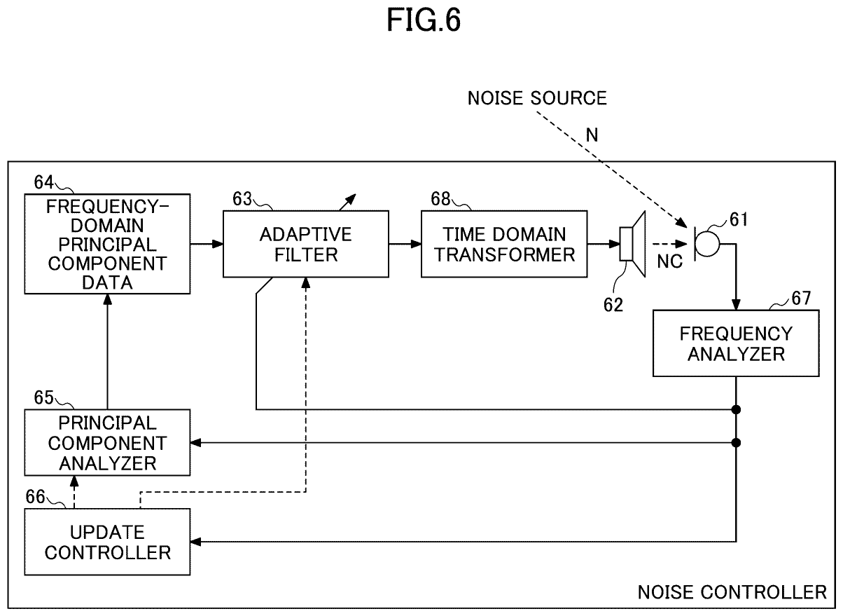

FIG. 6 shows the configuration of the noise controller according to the sixth embodiment.

As shown in FIG. 6, the noise controller includes a microphone 61 arranged near a target position where a noise is to be canceled, a speaker 62 that outputs a noise cancellation sound NC for canceling a noise N at the target position, an adaptive filter 63, frequency-domain principal component data 64, a principal component analyzer 65, an update controller 66, a frequency analyzer 67, and a time domain transformer 68.

The frequency analyzer 67 performs frequency analysis on monitoring sound data that is output from the microphone 61, and converts a monitoring sound to frequency-domain monitoring sound data that represents a sound intensity in each frequency band.

In the frequency analysis performed by the frequency analyzer 67, a fast Fourier transform (FFT) can be used, for example. When the FFT is used, the frequency-domain monitoring sound data represents a frequency spectrum.

When the noise control device is set up, or it is detected that the sound level represented by the monitoring sound data output from the microphone 61 becomes greater than or equal to a predetermined level with reference to the frequency-domain monitoring sound data, the update controller 66 stops the operation of the adaptive filter 63, and causes the principal component analyzer 65 to perform principal component analysis.

By principal component analysis in the frequency domain, the principal component analyzer 65 analyzes one or more principal components (e.g., only a first principal component, only a second principal component, or both the first principal component and the second principal component) having predetermined orders of the frequency-domain monitoring sound data. Then, the principal component analyzer 65 stores, as the frequency-domain principal component data 64, data representing a frequency domain sound having a maximum cumulative contribution ratio for one or more analyzed principal components.

When the FFT is used in frequency analysis performed by the frequency analyzer 67, the frequency-domain principal component data 64 represents a frequency spectrum.

When the frequency-domain principal component data 64 is stored, the update controller 66 resumes the operation of the adaptive filter 63.

The stored frequency-domain principal component data 64 is output to the adaptive filter 63 as frequency-domain pseudo noise data.

As frequency-domain noise cancellation sound data, the adaptive filter 63 outputs, to the time domain transformer 68, data that is obtained by filtering input frequency-domain pseudo noise data in the frequency domain. In addition, the adaptive filter 63 adapts, as an error of the frequency-domain monitoring sound data output from the frequency analyzer 67, a filter coefficient used in filtering the frequency-domain pseudo noise data by an adaptive algorithm such as LMS or NLMS, so as to minimize error power.

The time domain transformer 68 converts the frequency-domain noise cancellation sound data output from the adaptive filter 63, to a time domain sound, and outputs, from the speaker 62, the time domain sound as the noise cancellation sound NC.

When the FFT is used in the frequency analysis performed by the frequency analyzer 67, an inverse fast Fourier transform (IFFT) is performed by the time domain transformer 68.

Hereinafter, a seventh embodiment will be described.

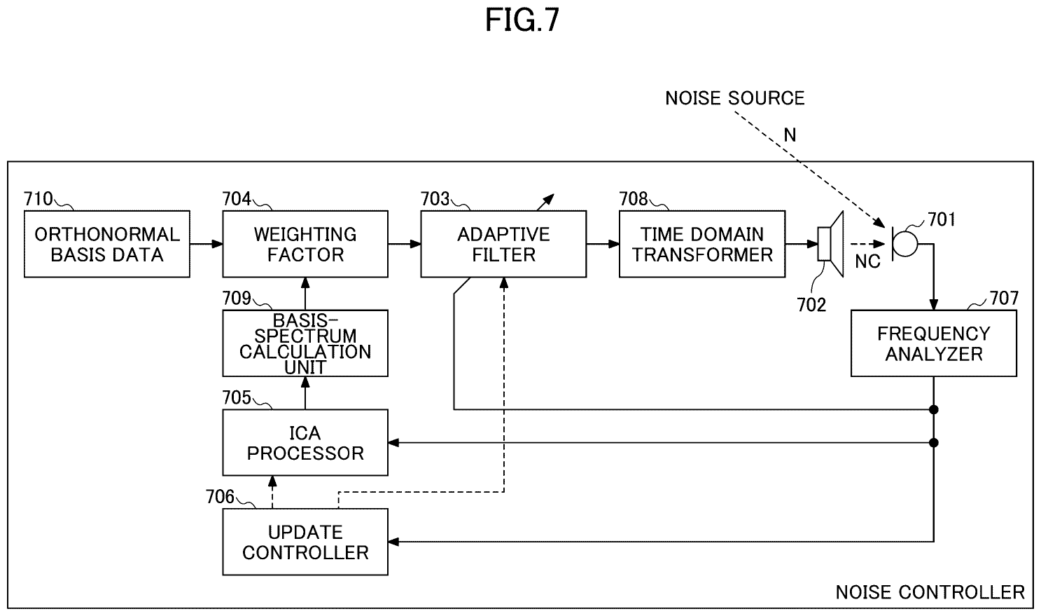

FIG. 7 shows the configuration of the noise controller according to the seventh embodiment.

As shown in FIG. 7, the noise controller includes a microphone 701 arranged near a target position where a noise is to be canceled, a speaker 702 that outputs a noise cancellation sound NC for canceling a noise N at the target position, an adaptive filter 703, a weighting factor 704, an ICA processor 705 for performing independent component analysis (ICA), an update controller 706, a frequency analyzer 707, a time domain transformer 708, a basis-spectrum calculation unit 709, and orthonormal basis data 710.

The orthonormal basis data 710 is orthonormal basis data used in a transformation function for generating a time domain signal by weighting a predetermined orthonormal basis with a weight. An inverse fast Fourier transform or the like can be used as such a transformation function. When the inverse fast Fourier transform is used, the orthonormal basis data 710 becomes Fourier basis data.

The frequency analyzer 707 performs frequency analysis on monitoring sound data that is output from the microphone 701, and converts the monitoring sound data to frequency-domain monitoring sound data that represents a weighting factor of the orthonormal basis of the transformation function described above.

Here, when the orthonormal basis data 710 is used as the Fourier basis data, a fast Fourier transform (FFT) is used in the frequency analysis performed by the frequency analyzer 707, and the frequency-domain monitoring sound data represents a frequency spectrum.

When the noise control device is set up, or it is detected that a sound level represented by the monitoring sound data output from the microphone 701 becomes greater than or equal to a predetermined level with reference to the frequency-domain monitoring sound data, the update controller 706 stops the operation of the adaptive filter 703, and causes the ICA processor 705 to perform an independent component analysis process.

In the independent component analysis process, the ICA processor 705 performs independent component analysis in the frequency domain, then separates data representing a noise component in the frequency domain, from the frequency-domain monitoring sound data based on statistical independence, and ultimately sends, as frequency-domain statistical noise data, the data separated from the frequency-domain monitoring sound data, to the basis-spectrum calculation unit 709.

The basis-spectrum calculation unit 709 calculates a complex spectrum for elements of the orthonormal basis that are stored in the orthonormal basis data 710, and the complex spectrum relates to a frequency domain noise represented by the frequency-domain statistical noise data sent from the ICA processor 705. Then, the basis-spectrum calculation unit 709 sets a weighting factor of an orthonormal basis that is determined from the calculated complex spectrum, as the weighting factor 704.

The complex spectrum calculated by the basis-spectrum calculation unit 709 represents a gain and a phase, and the weighting factor stored in the weighting factor 704 represents a gain and a phase applied to each element of the orthonormal basis in a complex form.

When the FFT is used in frequency analysis performed by the frequency analyzer 707, the weighting factor stored in the weighting factor 704 defines a frequency spectrum.

When the weighting factor 704 is stored, the update controller 706 resumes the operation of the adaptive filter 703.

The stored weighting factor 704 is output to the adaptive filter 703 as frequency-domain pseudo noise data representing the weighting factor of the orthonormal basis that is stored in the orthonormal basis data 710.

As frequency-domain noise cancellation sound data, the adaptive filter 703 outputs, to the time domain transformer 708, data that is obtained by filtering input frequency-domain pseudo noise data in the frequency domain. In addition, the adaptive filter 703 adapts, as an error of the frequency-domain monitoring sound data output from the frequency analyzer 707, a filter coefficient used in filtering the frequency-domain pseudo noise data by an adaptive algorithm such as LMS or NLMS, so as to minimize error power.

The time domain transformer 708 converts the frequency-domain noise cancellation sound data output from the adaptive filter 703, to a time domain sound, and outputs, from the speaker 702, the time domain sound as the noise cancellation sound NC.

When the FFT is used in the frequency analysis performed by the frequency analyzer 707, an inverse fast Fourier transform (IFFT) is performed by the time domain transformer 708.

In the above seventh embodiment, instead of the ICA processor 15, the following processor may be provided. That is, by use of a trained neural network or principal component analysis, the processor separates data representing a frequency domain noise, from frequency-domain monitoring sound data, and sets the data separated from the frequency-domain monitoring sound data, as frequency-domain statistical noise data.

Hereinafter, an eighth embodiment will be described.

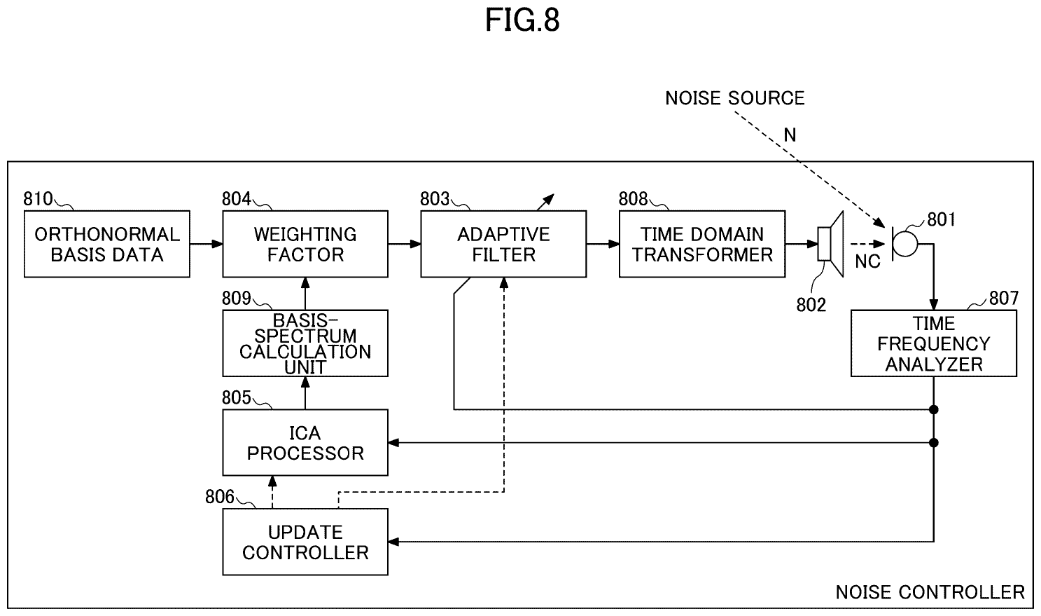

FIG. 8 shows the configuration of the noise controller according to the eighth embodiment.

As shown in FIG. 8, the noise controller includes a microphone 801 arranged near a target position where a noise is to be canceled, a speaker 802 for outputting a noise cancellation sound NC for canceling a noise N at the target position, an adaptive filter 803, a weighting factor 804, an ICA processor 805 for performing independent component analysis (ICA), an update controller 806, a time-frequency analyzer 807, a time domain transformer 808, a basis-spectrum calculation unit 809, and orthonormal basis data 810.

The orthonormal basis data 810 is orthonormal basis data used in a transformation function for generating a time-domain signal in which a frequency spectrum varies with time by weighting a predetermined orthonormal basis. An inverse wavelet transform or the like can be used as such a transformation function. When the inverse wavelet transform is used, the orthonormal basis data 810 becomes wavelet basis data. Here, the wavelet basis is typically obtained by varying a scale and time shift in a mother wavelet.

The time-frequency analyzer 807 performs time-frequency analysis on monitoring sound data output from the microphone 801, and converts the monitoring sound data to time-frequency domain monitoring sound data representing a weighting factor of an orthonormal basis of the transformation function described above.

Here, when the orthonormal basis data 810 is wavelet basis data, a wavelet transform is used in the time-frequency analysis performed by the frequency analyzer, and the time-frequency domain monitoring sound data represents a wavelet coefficient.

When the noise controller is set up, or it is detected that a sound level represented by the monitoring sound data output from the microphone 801 becomes greater than or equal to a predetermined level with reference to the time-frequency domain monitoring sound data, the update controller 806 stops the operation of the adaptive filter 803, and causes the ICA processor 805 to perform an independent component analysis process.

In the independent component analysis process, the ICA processor 805 performs independent component analysis in the time-frequency domain, separates data representing a noise component in the time-frequency domain from the time-frequency domain monitoring sound data based on statistical independence, and ultimately sends the data as time-frequency domain statistical noise data to the basis-spectrum calculation unit 809.

The basis-spectrum calculation unit 809 calculates a spectrum for elements of the orthonormal basis stored in the orthonormal basis data 810, and the spectrum relates to a time-frequency domain noise represented by the time-frequency domain statistical noise data sent from the ICA processor 805. The basis-spectrum calculation unit 809 sets a weighting factor of the orthonormal basis that is derived from the calculated spectrum, as the weighting factor 804.

When the wavelet transform is used in the frequency analysis performed by the frequency analyzer, the weighting factor stored in the weighting factor 804 represents a wavelet coefficient.

When the weighting factor 804 is stored, the update controller 806 resumes the operation of the adaptive filter 803.

The stored weighting factor 804 is output to the adaptive filter 803 as time-frequency domain pseudo noise data representing the weighting factor of the orthonormal basis stored in the orthonormal basis data 810.

The adaptive filter 803 filters input time-frequency domain pseudo noise data in the frequency domain, and outputs the resulting data to the time domain transformer 808 as time-frequency domain noise cancellation sound data. The adaptive filter 803 adapts, as an error of the time-frequency domain monitoring sound data output from the time-frequency analyzer 807, a filter coefficient used in filtering the time-frequency domain pseudo noise data by an adaptive algorithm such as LMS or NLMS, so as to minimize error power.

The time-domain transformer 808 converts the time-frequency domain noise cancellation sound data output from the adaptive filter 803, to a time domain sound, and outputs, from the speaker 802, the time domain sound as the noise cancellation sound NC.

When the wavelet transform is used in the frequency analysis performed by the time-frequency analyzer 807, an inverse wavelet transform is performed by the time-domain transformer 808.

In the above eighth embodiment, instead of the ICA processor 15, the following processor may be provided. That is, by use of a trained neural network or principal component analysis, the processor separates data representing a time-frequency domain noise, from time-frequency domain monitoring sound data, and sets the data as the time-frequency domain statistical noise data. The eighth embodiment has been described above.

In the above-described embodiments, a noise component can be analyzed and stored based on a sound collected by the microphone for collecting an error that adapts to the adaptive filter. Then, pseudo noise data representing a stored noise component can be used as an input of the adaptive filter to generate a noise cancellation sound by active noise control. In addition, unlike the feedback active noise control, there is no problem in delay in propagation of a feedback loop, which causes the noise to be not canceled successfully in a high frequency domain. Moreover, since pseudo noise data stored in advance is used as the input of the adaptive filter, in a feedforward active noise control, when a sensor for detecting an event that correlates with a noise at the position upstream of the noise from a target position where the noise is to be canceled is close to the target position, there is no problem in an insufficient computational time, which causes the noise to be not canceled successfully.

In this arrangement, according to the embodiments, in a blind configuration that does not include a sensor for detecting any event correlating with a noise at a position upstream of the noise from a target position, an active noise control that can cancel the noise successfully in the high-frequency domain can be performed.

Here, as the weighting factor 704 in the above-described seventh embodiment, a weighting factor that is fixed in advance may be used.

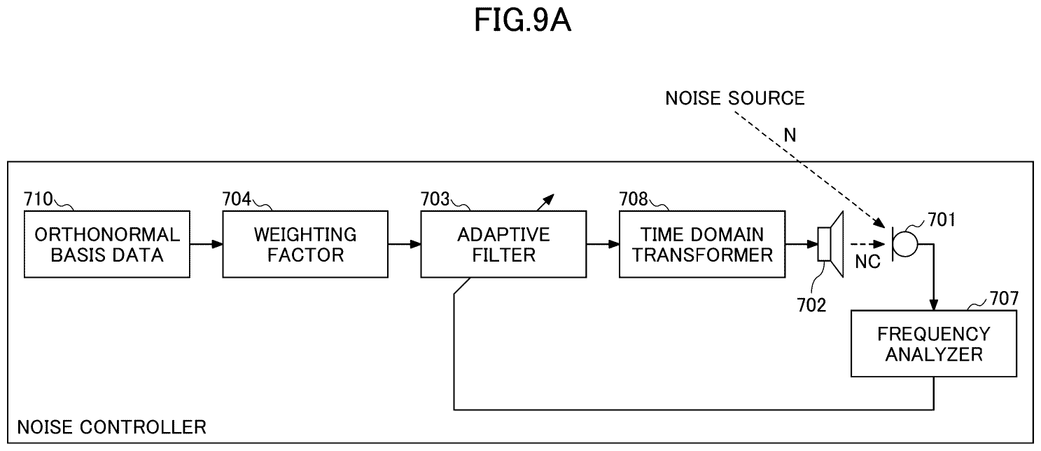

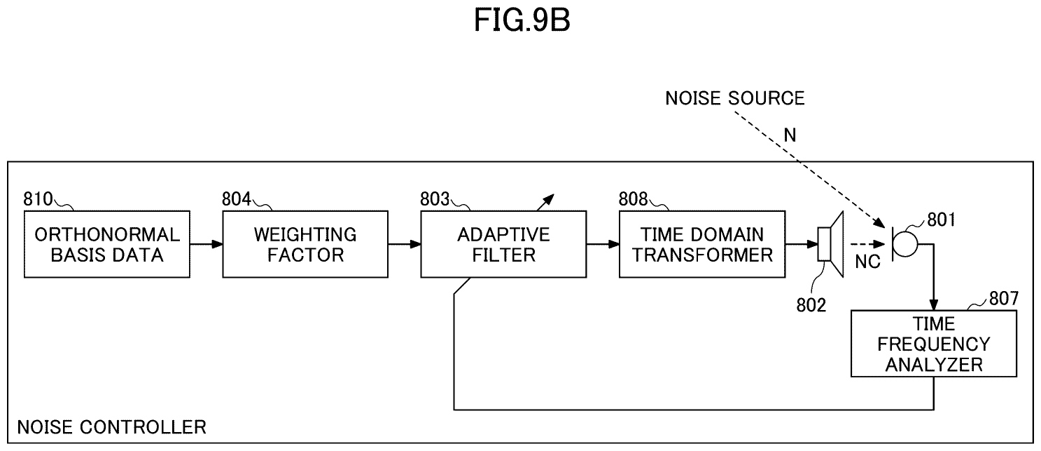

That is, in this case, as shown in FIG. 9A, the ICA processor 705, the update controller 706, and the basis-spectrum calculation unit 709 are eliminated. The weighting factor of the orthonormal basis that is determined by preliminarily performing analysis or the like is preset as the weighting factor 704.

Similarly, as the weighting factor 804 in the eighth embodiment, a weighting factor fixed in advance may be used.

That is, in this case, as shown in FIG. 9B, the ICA processor 805, the update controller 806, and the basis-spectrum calculation unit 809 are eliminated. The weighting factor of the orthonormal basis that is determined by preliminarily performing analysis or the like is preset as the weighting factor 804.

With these arrangements, noises can be successfully canceled even in the high frequency range, using a blind configuration that does not include any sensor that detects an event correlating with a noise at a position upstream of the target position.

In the present disclosure, an active noise control capable of successfully canceling a noise even in a high frequency range can be implemented, by using a blind configuration with no sensor for detecting an event correlating with the noise at a position upstream of the noise from a target position where the noise is to be canceled.

What is claimed is:

1. An active noise control system comprising:
a microphone configured to output a collected sound as a monitoring signal;
a speaker configured to output a noise cancellation sound;
an adaptive filter;
a storage; and
circuitry configured to perform a noise separation process at a predetermined timing, the noise separation process including
separating a noise component from the monitoring signal, and
storing, in the storage, a pseudo noise signal representing the noise component,
wherein the adaptive filter is configured to
receive an input of the pseudo noise signal stored in the storage, and
perform an adaptive operation to adapt the monitoring signal as an error, and generate the noise cancellation sound to be output from the speaker based on the pseudo noise signal.

2. An active noise control system comprising:
a microphone;
circuitry configured to convert an output of the microphone to a frequency domain signal, and output the frequency domain signal as a monitoring signal;
a speaker configured to output a noise cancellation sound;
an adaptive filter; and
a storage,
wherein the circuitry is configured to perform a noise separation process at a predetermined timing, the noise separation process including
separating a noise component from the monitoring signal in a frequency domain, and
storing, in the storage, a pseudo noise signal representing the noise component in the frequency domain,
wherein the adaptive filter is configured to receive an input of the pseudo noise signal stored in the storage, and perform an adaptive operation in the frequency domain to adapt the monitoring signal as an error, and
wherein the circuitry is configured to convert an output of the adaptive filter to a time domain signal, and generate the noise cancellation sound to be output from the speaker.

3. The active noise control system according to claim 2, wherein the circuitry is configured to
convert the output of the microphone to the frequency domain signal by a fast Fourier transform, and output the frequency domain signal as the monitoring signal, and
convert the output of the adaptive filter to the time domain signal by an inverse fast Fourier transform.

4. An active noise control system comprising:
a microphone;
circuitry configured to convert an output of the microphone to a weighting factor of a predetermined transformation function that generates a time domain signal by weighting an orthonormal basis, and output the weighting factor as a monitoring signal;
a speaker configured to output a noise cancellation sound;
an adaptive filter; and
a storage,
wherein the circuitry is configured to perform a noise separation process at a predetermined timing, the noise separation process including
separating a noise component from the monitoring signal and storing the noise component in the storage as a pseudo noise signal,
wherein the adaptive filter is configured to receive an input of the pseudo noise signal stored in the storage, and perform an adaptive operation to adapt the monitoring signal as an error, and
wherein the circuitry is configured to convert an output of the adaptive filter to the time domain signal by the transformation function, and generate the noise cancellation sound to be output from the speaker.

5. The active noise control system according to claim 4, wherein the circuitry is configured to
convert the output of the microphone to a frequency domain signal by a fast Fourier transform, and output the frequency domain signal as the monitoring signal, and
convert an output of the adaptive filter to the time domain signal by an inverse fast Fourier transform.

6. The active noise control system according to claim 4, wherein the circuitry is configured to
convert the output of the microphone to the weighting factor by a wavelet transform, and output the weighting factor as the monitoring signal, and
convert the output of the adaptive filter to the time domain signal by an inverse wavelet transform.

7. The active noise control system according to claim 1, wherein the circuitry is configured to perform the noise separation process at the predetermined timing at which the output of the microphone becomes greater than a predetermined level.

8. The active noise control system according to claim 1, wherein the circuitry is configured to separate the noise component from the monitoring signal by independent component analysis.

9. The active noise control system according to claim 1, wherein the circuitry is configured to infer and separate the noise component from the monitoring signal by a neural network that is preliminarily trained to infer the noise component from the monitoring signal.

10. The active noise control system according to claim 1, wherein the circuitry is configured to calculate a principal component having a predetermined order of the monitoring signal by performing principal component analysis, and separate the principal component as the noise component.

11. An active noise control system comprising:
a microphone;
circuitry configured to
convert an output of the microphone to a weighting factor of a predetermined transformation function that generates a time domain signal by weighting an orthonormal basis, and
output the weighting factor as a monitoring signal;
a speaker configured to output a noise cancellation sound;
an adaptive filter; and
a storage that preliminarily stores, as a pseudo noise signal, the weight factor with which a pseudo noise is generated by the transformation function,
wherein the adaptive filter is configured to receive an input of the pseudo noise signal stored in the storage, and perform an adaptive operation to adapt the monitoring signal as an error, and
wherein the circuitry is configured to convert an output of the adaptive filter to the time domain signal by the transformation function, and generate the noise cancellation sound to be output from the speaker.

12. The active noise control system according to claim 11, wherein the circuitry is configured to
convert the output of the microphone to the weighting factor by a fast Fourier transform, and output the weighting factor as the monitoring signal, and
convert the output of the adaptive filter to the time domain signal by an inverse fast Fourier transform.

13. The active noise control system according to claim 11, wherein the circuitry is configured to
convert the output of the microphone to the weighting factor by a wavelet transform, and output the weighting factor as the monitoring signal, and
convert the output of the adaptive filter to the time domain signal by an inverse wavelet transform.
